(19) United States
(12) Patent Application Publication
(10) Pub. No.: US 2007/0070874 A1
(43) Pub. Date: Mar. 29, 2007

(54) Recording apparatus and method for recording information on a record carrier in the form of contiguous pit-marks

(75) Inventors: Albert Hendrik Jan Immink, Eindhoven (NL); Alexander Marc Van Der Lee, Eindhoven (NL); Dominique Maria Bruls, Eindhoven (NL); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,103

(22) PCT Filed: Oct. 20, 2004
(86) PCT No.: PCT/IB04/52147

§ 371 Date: Apr. 25, 2006

(30) Foreign Application Priority Data
Oct. 29, 2003 (EP) 03103999.3

(51) Int. Cl. G11B 7/24

(52) U.S. Cl. 369/275.4

(57) ABSTRACT

A recording apparatus for recording channel symbols of a channel data stream on a record carrier (50), said apparatus being adapted for recording said channel symbols as a channel band (cb) of at least two symbol rows (sr) one-dimensionally evolving along a first direction (t) and aligned with each other along a second direction (r), said two directions constituting a two-dimensional lattice of symbol cells (sc) each being associated with a symbol area (sa) of the record carrier (50). To reduce the occurrence of leading and trailing edges of pit-marks in the recorded channel band, and in order to be able to write a small radial extent in said second direction in view of limiting cross-write effects, it is proposed to record a channel symbols in the form of a mark area (rpm) having a longitudial shape of a length in said first direction (1) substantially equal to the length of a symbol area (sa) in said first direction (t) and of a width in said second direction (r) being smaller than the width of a symbol area (sa) in said second direction (sa).

The present invention relates to a recording apparatus for recording channel symbols of a channel data stream on a record carrier, said apparatus being adapted for recording said channel symbols as a channel band of at least two symbol rows one-dimensionally evolving along a first direction and aligned with each other along a second direction, said two directions constituting a two-dimensional lattice of symbol cells each being associated with a symbol area of the record carrier. The present invention relates further to a corresponding recording method and record carrier on which an information can be recorded.

In optical systems for data storage use can be made of a multi-track read-out with bits or, more generally, symbols stacked upon a 2D lattice. This applies, for instance, in the 2D optical storage system developed in a project called TwoDOS, which is a new concept for two-dimensional optical storage where the information on the record carrier fundamentally has a two-dimensional character. The aim is to realize an increased data density and an increased data rate. Such a 2D optical storage system has, for instance, been described in European patent application 02076665.5 (PHNL 020368).

A writing scheme for writing an information to an optical recording medium by forming mark areas, e.g. pit areas, corresponding to a predetermined state of said information on a recording surface of said optical recording medium has been described in European patent application 02076255.5 (PHNL 020279). The writing scheme is adapted to modulate the shape of said mark areas in a predetermined manner so as to obtain incomplete mark areas which do not fully cover the size of the bit (or symbol) cell which is allocated to the channel bit (or symbol) to be written. Thereby, the problem of signal folding can be prevented or alleviated during the writing or mastering process due to the fact that the incomplete mark areas, e.g. pit effects, do not form large contiguous mirror surfaces, which would be equal to large contiguous non-mark areas, when combined in clusters of adjacent pits. The incomplete mark areas may be obtained by modulating their shape in any manner suitable to reduce the reflection surface and/or to increase diffraction outside of the central aperture used for the physical detection. Additionally, a multi-level modulation or a binary modulation may be achieved by controlling the shape or number of the incomplete mark areas, respectively, in accordance with the level of a multi-level coded information.

Small circular pit-hole marks can be successfully written with an electron beam recorder (EBR) for the production of a master disc (in the case of read-only media, i.e. ROM media). However, there are physical write-channels in which it is preferable to write quite narrow pit-marks in the radial direction. For instance, in a rewritable version of the (TwoDOS) multi-track format, e.g. based on phase-change recording, such narrow pit-marks may be advantageous for reducing the cross-write effects when writing the tracks very close together in the radial direction. The writing of tracks very close together in the radial direction is required for a 2D format based on a 2D close-packed lattice like the hexagonal 2D lattice.

Another aspect of (small) pit-hole mastering is that media noise can be quite large when the pit-holes are each individually written as separate write-operations on the medium. Due to the blanking of the electron beam in an EBR mastering set-up, the leading and trailing edges of a pit-mark may be quite jittery. So it may be beneficial to limit the occurrence of leading and trailing edges. Also in a rewritable application with phase-change recording, the jitter of the mark edges is an important contribution to the media noise which should be minimized.

It is thus an object of the present invention to provide a record carrier, a recording method and a recording apparatus by which the occurrence of leading and trailing edges of pit-marks can be reduced so that the storage capacity can be increased for a given writing/recording technology.

This object is achieved according to the present invention by a recording apparatus as claimed in claim 1, which is adapted for recording a channel symbol in the form of a mark area having a longitudinal shape of a length in said first direction substantially equal to the length of a symbol area in said first direction and of a width in said second direction being smaller than the width of a symbol area in said second direction.

A corresponding recording method and an appropriate record carrier are defined in claims 9 and 10. Preferred embodiments of the invention are defined in the dependent claims.

The invention is based on the idea to limit the number of trailing and leading edges by writing pit-marks (also called mark areas) of a longitudinal shape that have a small dimension in the radial direction (second direction) and that cover the complete symbol area, which is also referred to as bit cell, in the tangential direction (first direction) of the broad spiral which is the direction along which the writing proceeds. In case several “1”-bits have to be written along a given symbol row of the broad spiral, then a single long contiguous pit-mark results with only one leading and one trailing edge. In this way the contribution to the media noise resulting from mark-edge jitter can be reduced.

According to a preferred embodiment the mark area has a rectangular or a square shape where, preferably, the extent of the mark in the radial direction (the second direction of the broad spiral) is almost constant. Such a choice leads to well-controlled position-invariant intersymbol-interference at the different bit positions within a given mark area.

According to another embodiment the mark area covers less than 75% of the associated symbol area, in particular between 45% and 55% of the associated symbol area. This has the advantage that signal folding can be avoided as has been described in the above mentioned European patent application 02076255.5 (PHNL 020279). A preferred coverage value is approximately 50%.

A mark area can be represented by different means. Preferred means, in particular for a ROM disc, are pit areas comprising a pillar portion or a circular or rectangular hole. Preferably, in an embodiment of the present invention, the pit-area is a rectangularly shaped pillar portion or rectangularly shaped hole. Preferred means, in particular for a rewritable phase-change disc or a recordable disc, are pit areas comprising a rectangularly shaped amorphous area within a polycrystalline environment or pit areas comprising a rectangularly shaped polycrystalline area with an amorphous environment.

The invention is generally applicable in multi-dimensional coding, i.e. two- or more-dimensional coding, particularly in 2D coding as proposed in the TwoDOS project. The symbol cells can be arranged on the lattice points of any kind of lattice, such as a quasi-hexagonal, quasi-rectangular or quasi-square lattice and may have different shapes, such as a hexagonal, rectangular or square shape, respectively. Preferably a hexagonal shape is applied in the TwoDOS system, and the symbol cells are arranged on the lattice points of a quasi-hexagonal lattice.

The present invention will now be explained in more detail with reference to the drawings in which

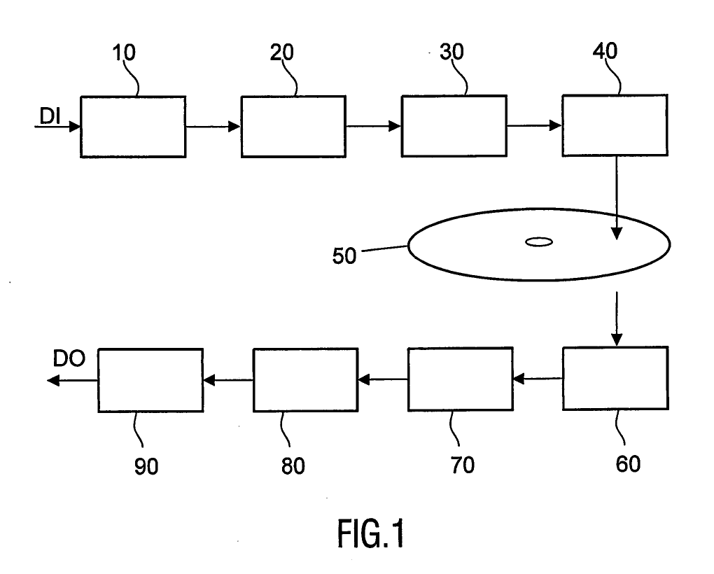

FIG. 1 shows a block diagram of a general layout of a coding system,

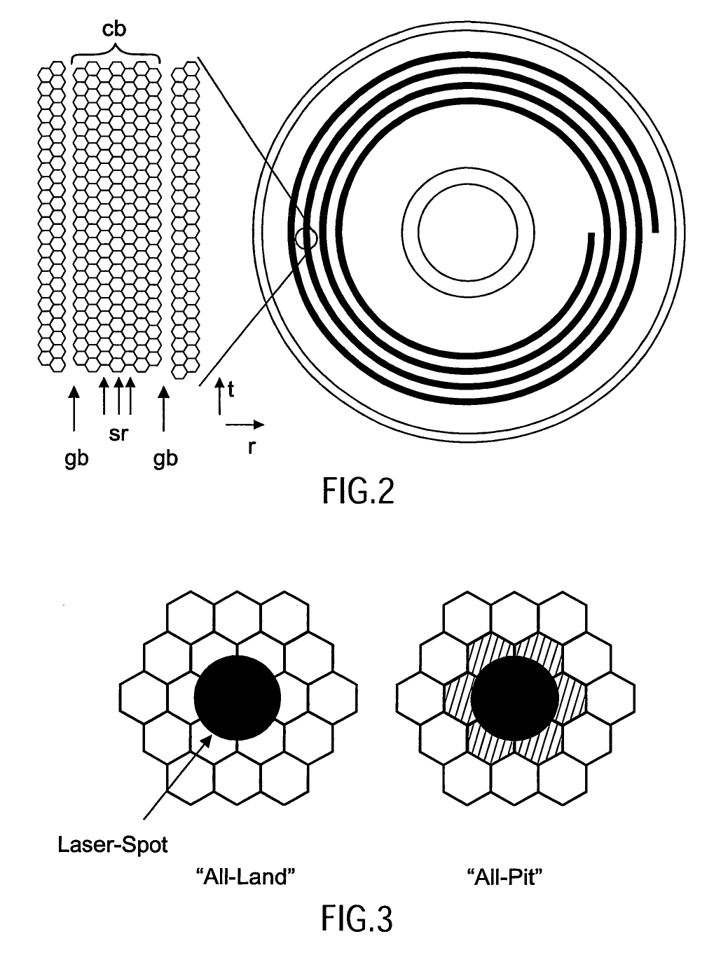

FIG. 2 shows a schematic format with a section of a 2D broad spiral using a hexagonal lattice,

FIG. 3 shows a large land area and a large pit area in the known 2D coding system using pit-marks that cover the complete symbol-cell,

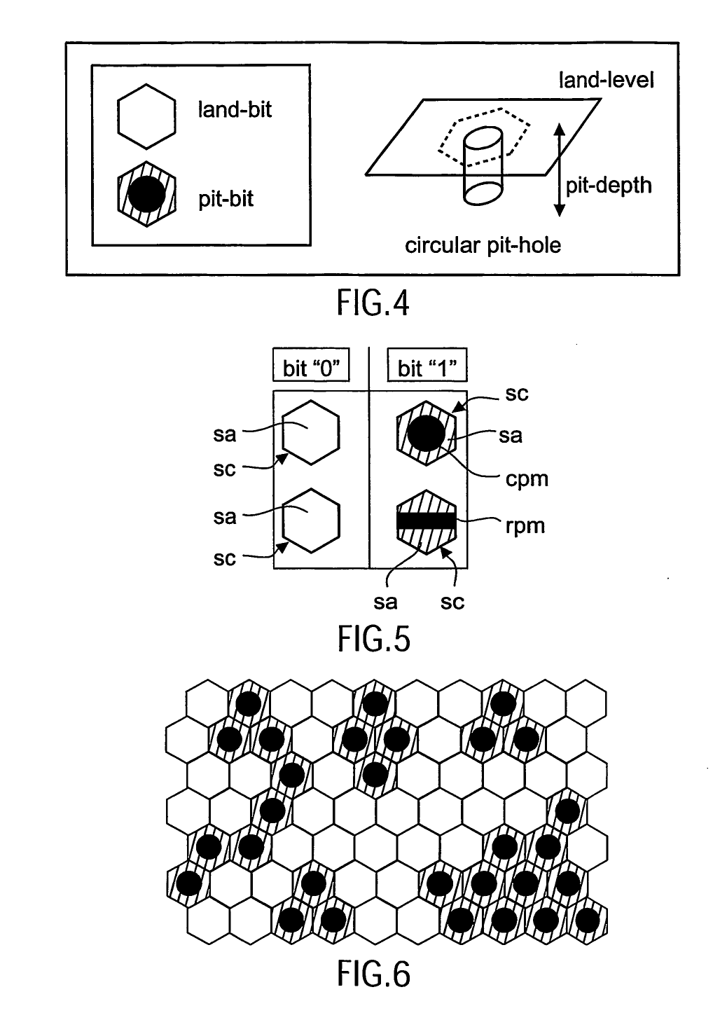

FIG. 4 shows a circular pit-geometry in the known 2D coding system using pit-marks that cover only a fraction of the complete symbol-cell,

FIG. 5 shows a comparison between known circular pit-marks and new rectangular pit-marks,

FIG. 6 shows a schematic diagram of a 2D broad spiral used in the known 2D coding system using pit-marks that cover only a fraction of the complete symbol-cell,

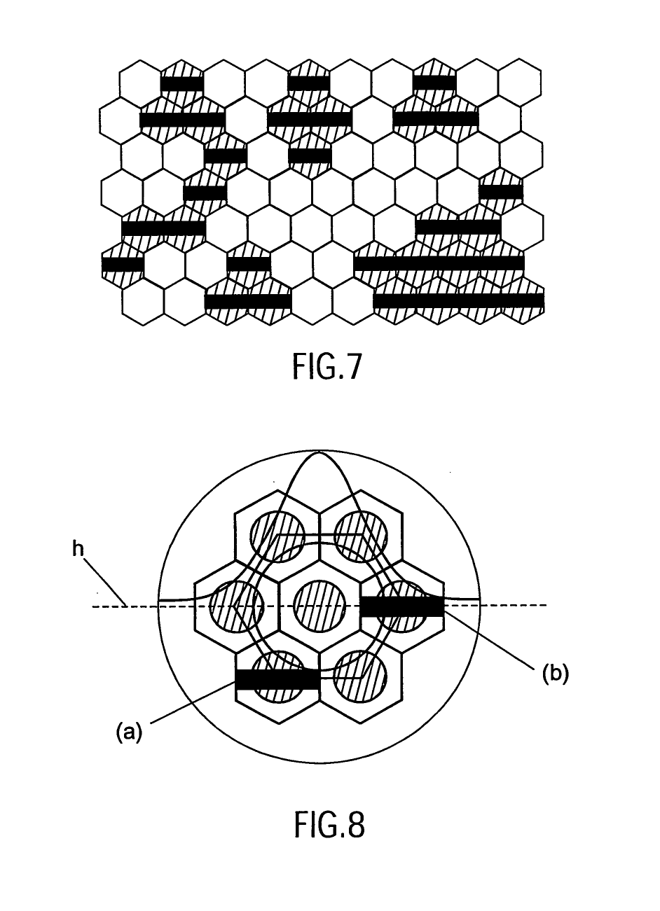

FIG. 7 shows a schematic diagram of a 2D broad spiral according to the invention, and

FIG. 8 shows the geometry of the spot-profile for known and for new pit-marks.

FIG. 1 shows typical coding and signal processing elements of a data storage system. The cycle of user data from input DI to output DO can include interleaving 10, error-correction-code (ECC) and modulation encoding 20, 30, signal preprocessing 40, data storage on the recording medium 50, signal post-processing 60, binary detection 70, and decoding 80, 90 of the modulation code, and of the interleaved ECC. The ECC encoder 20 adds redundancy to the data in order to provide protection against errors from various noise sources. The ECC-encoded data are then passed on to a modulation encoder 30 which adapts the data to the channel, i.e. it manipulates the data into a form less likely to be corrupted by channel errors and more easily detected at the channel output. The modulated data are then input to a recording device, e.g. a spatial light modulator or the like, and stored in the recording medium 50. On the retrieving side, the reading device (e.g. photo-detector device or charge-coupled device (CCD)) returns pseudo-analog data values which must be transformed back into digital data (one bit per pixel for binary modulation schemes). The first step in this process is a post-processing step 60, called equalization, which attempts to undo distortions created in the recording process, still in the pseudo-analog domain. Then the array of pseudo-analog values is converted to an array of binary digital data via a bit detector 70. The array of digital data is then passed first to the modulation decoder 80, which performs the inverse operation to modulation encoding, and then to an ECC decoder 90.

In the known 2D (TwoDOS) coding system, the channel symbols are organized in a broad spiral as illustrated in FIG. 2. Such a spiral consists of a number of symbol rows stacked upon each other with a fixed phase relation in the radial direction, so that the symbols are arranged on a 2D lattice. A 2D closed-packed hexagonal ordering of the symbols is preferably chosen because it has a 15% higher packing fraction than a square lattice. Successive revolutions of the broad spiral are separated by a guard band consisting of one empty symbol row as shown in FIG. 2. A multi-spot light-path for parallel readout is provided, where each spot has BD (Blu-ray Disc) characteristics. The signal processing with equalization, timing recovery and symbol-detection is carried out in a 2D fashion, that is, jointly over all the symbol rows within the broad spiral.

The problem of signal folding is a bit-detection issue that is typical for the coherent signal generation as is used in 2D coding. First, it is noted that the reflection signal from a large land portion (mirror at zero-level) and from a large contiguous pit portion (mirror below zero-level, at depth λ′/4, with λ′ the wavelength of the light used inside the cover-layer above the information layer of the disc) are completely identical. FIG. 3 shows a schematic drawing of both situations. In traditional 1D runlength-limited (RLL) coding, a run of successive pit-bits is written as one large contiguous pit (or mark). The radial width of a mark is always a fraction of the distance between successive tracks (the track-pitch). The problem of signal folding does not arise in 1D-RLL coding because the spot diameter is always larger than the radial width of a pit: this leads to diffraction in the radial direction, so that the reflected light beam loses some intensity (by diffraction outside the central aperture (CA) that is used for the physical detection). In 2D coding on the other hand, the problem of signal folding may arise due to the possible occurrence of large contiguous pit areas, consisting of a number of neighbouring bits, all (or almost all) of the pit-type. It should be noted that there is no diffraction at all for a focused laser spot that is incident on a large pit area (using pit-marks that cover the complete symbol-cell for each symbol), or on a large land area since both behave as ideal mirrors.

One of the main reasons to avoid signal folding originates from the signal processing and bit detection to be used in 2D coding. A highly desirable property is that the HF signal values show a systematic roll-off, which means that the value of the signal waveform decreases as the number of neighbour “1”-bits (bits of the pit-type) increases: this property must hold for both possible bit-values for the central bit. In case of signal folding, (part of) the HF signal values increase (instead of decrease) with an increasing number of neighbour pit-bits (when the central bit is of the pit-type, that is, a “1” bit): this effect might obstruct robust bit-detection, even in the case of moderate (media) noise.

Signal folding typically occurs when the pit-bits are physically written (e.g. mastered in a ROM disc) such that the pit-area covers a large fraction of or even the complete area of a symbol cell, which is preferably a hexagon, the fundamental cell of the 2D hexagonal lattice. According to the above mentioned European patent application 02076255.5 (PHNL 020279) the elimination of signal folding is achieved through the writing of (relatively much) smaller pit-holes than the ones that are maximally possible: a quite convenient roll-off of the signal values is achieved for a so-called duty factor of 50%, that is, the pit-hole covers about half of the symbol area of the available hexagon. The above insight has resulted in the following strategy for the write-channel in TwoDOS: each pit-symbol is recorded as a separate (preferably circular) pit-hole with a size smaller than the size of the hexagonal symbol cell. The geometry of a pit-symbol is illustrated in FIG. 4. In this way, large contiguous areas of pit-marks are avoided, hereby eliminating the problem of signal folding.

However, as explained above, it might be preferable to write narrow pit-marks, in particular on rewritable record carriers having a recording layer including a phase-change material, since, by use of such narrow pit-marks, cross-write effects can be reduced. Further, it may be preferable to limit the number of leading and trailing edges of pit-marks in order to reduce jitter resulting therefrom, where leading and trailing edges are referred to the tangential direction of the writing process, along the first direction of the broad spiral.

FIG. 5 shows the new write-strategy with rectangular pit-marks rpm compared to the original one with circular pit-marks cpm, both filling approximately 50% of the mark area of the associated symbol cell sc. FIGS. 6 and 7 show schematic drawings of a part of a TwoDOS spiral for the two write strategies.

In an embodiment as proposed in the TwoDOS project a hexagonal lattice is proposed with a hexagonal lattice parameter (distance between the centers of symbol cells) in the amount of a=165 nm. For the circular pit-mark, the optimal pit-hole size is derived from a 50% filling criterion of the hexagonal symbol-cell that is available for each symbol as described above. This leads to a pit-hole diameter b given by b_{50%}/=a √(√3/π). This gives b_{50%}=122 nm, so that the pit-hole area equals S=11789 nm². For the rectangular pit-mark, this leads to a radial width of w=71.5 nm (with a length of the pit-mark equal to 1=a=165 nm).

In a further embodiment directed to obtaining a higher capacity (e.g. 2× that of BD), the hexagonal lattice parameter amounts to a=138 nm. The diameter of the circular pit-hole amounts to b_{50%}-=102.5 nm so that the pit-hole area equals S=8246 nm². For the rectangular pit-mark, this leads to a radial width of w=60 nm (with a length of the pit-mark equal to 1=a=138 nm).

FIG. 8 shows the spot-shape relative to the bit-lattice for the case that the lattice parameter equals a=165 nm (for Blu-ray Disc parameters, λ=405 nm, NA=0.85). In case of the circular pit-holes, it is clear that the inter-symbol-interference (ISI) will be rotationally symmetric. In case of the rectangular pit-marks, the ISI loses this property: pit-marks that are at a given position along the horizontal axis h through the center of the spot (case (b) in FIG. 8) will give rise to a larger interference than pit-marks at a position with also a radial offset to the center of the spot (case (a) in FIG. 8). The property of rotationally symmetric ISI can be restored by a proper distortion of the 2D lattice, by squeezing the radial dimension and stretching the tangential dimension of the lattice obtaining a primitive oblique lattice (while maintaining the capacity of the lattice to its original value).

The present invention can be applied in optical recording systems that are based on 2D coding, but also on 3D or multi-dimensional coding. 2D optical storage, e.g. as proposed in the TwoDOS project, where the bits are arranged on a 2D hexagonal lattice, has to cope with the issue of “signal folding” which is due to severe channel non-linearities. According to a known solution it was proposed to linearize the overall channel to a satisfactory level by assigning to each pit-bit a circular pit-mark that covers not more than 50% of the bit-cell. For some physical write-channels, the writing of isolated circular pit-marks can be disadvantageous, for instance, because of media noise that is caused by mark-edges that are jittery especially in the direction of writing. The present invention proposes to write for each pit-bit a rectangular pit-mark that covers the full tangential extent of the bit-cell, and that is consequently narrower in the radial direction of the spiral, so that a run of consecutive pit-bits is written as a single pit-mark, with one leading and one trailing edge. The total size of the pit-mark is preferably not more than 50% in order to avoid signal folding. The difference with the traditional 1D situation is that, for the 2D case, pit-marks on consecutive bit rows in the 2D broad spiral are aligned with each other. A consequence of the preferred use of rectangular pit-marks might be a small deviation from the rotational symmetry of the inter-symbol-interference (ISI) for the hexagonal lattice, which can be compensated by a slight distortion of the bit-lattice.

1. Recording apparatus for recording channel symbols of a channel data stream on a record carrier (50), said apparatus being adapted for recording said channel symbols as a channel band (cb) of at least two symbol rows (sr) one-dimensionally evolving along a first direction (t) and aligned with each other along a second direction (r), said two directions constituting a two-dimensional lattice of symbol cells (sc) each being associated with a symbol area (sa) of the record carrier (50), wherein a channel symbol is recorded in the form of a mark area (rpm) having a longitudinal shape of a length in said first direction (t) substantially equal to the length of a symbol area (sa) in said first direction (t) and of a width in said second direction (r) being smaller than the width of a symbol area (sa) in said second direction (sa).

2. Recording apparatus as claimed in claim 1,
wherein said mark area (rpm) has a rectangular or square shape.

3. Recording apparatus as claimed in claim 2,
wherein said mark area (rpm) is a pit area comprising a rectangularly shaped pillar portion or a rectangularly shaped hole.

4. Recording apparatus as claimed in claim 1,
wherein said mark area (rpm) covers less than 75% of the associated symbol area (sa), in particular between 45% and 55% of the associated symbol area (sa).

5. Recording apparatus as claimed in claim 1,
wherein said mark area (rpm) is a pit area comprising a rectangularly shaped amorphous area with a polycrystalline environment.

6. Recording apparatus as claimed in claim 1,
wherein said mark area (rpm) is a pit area comprising a rectangularly shaped polycrystalline area with an amorphous environment.

7. Recording apparatus as claimed in claim 1,
wherein said apparatus is adapted for arranging said symbol cells (sc) on the lattice points of a quasi-hexagonal, quasi-rectangular or quasi-square lattice and are arranged with a symbol area having a hexagonal, rectangular or square shape, respectively.

8. Method of recording channel symbols of a channel data stream on a record carrier (50), said channel symbols being recorded as a channel band (cb) of at least two symbol rows (sr) one-dimensionally evolving along a first direction (t) and aligned with each other along a second direction (r), said two directions constituting a two-dimensional lattice of symbol cells (sc) each being associated with a symbol area (sa) of the record carrier (50), wherein a channel symbol is recorded in the form of a mark area (rpm) having a longitudinal shape of a length in said first direction (t) substantially equal to the length of a symbol area (sa) in said first direction (t) and of a width in said second direction (r) being smaller than the width of a symbol area (sa) in said second direction (sa).

9. Record carrier on which channel symbols of a channel data stream are recorded as a channel band (cb) of at least two symbol rows (sr) one-dimensionally evolving along a first direction (t) and aligned with each other along a second direction (r), said two directions constituting a two-dimensional lattice of symbol cells (sc) each being associated with a symbol area (sa) of the record carrier (50), wherein a channel symbol is recorded in the form of a mark area (rpm) having a longitudinal shape of a length in said first direction (t) substantially equal to the length of a symbol area (sa) in said first direction (t) and of a width in said second direction (r) being smaller than the width of a symbol area (sa) in said second direction (sa).

10. Record carrier as claimed in claim 9,
wherein said record carrier (50) is a recordable or a rewritable record carrier, in particular having a phase-change recording layer.
